(19) United States
(12) Patent Application Publication
(10) Pub. No.: US 2026/0170214 A1
(43) Pub. Date: Jun. 18, 2026

(54) COMMUNICATION LINK LATENCY TOLERANCE FOR HARDWARE ASSISTED VERIFICATION SYSTEMS

(71) Applicant: Siemens Industry Software Inc., Plano, TX (US)

(72) Inventor: Charles W. Selvidge, Oakland, CA (US)

(73) Assignee: Siemens Industry Software Inc., Plano, TX (US)

(21) Appl. No.: 19/103,729

(22) PCT Filed: Aug. 31, 2022
(86) PCT No.: PCT/US2022/075731

§ 371 Date: Feb. 13, 2025

(51) Int. Cl. G06F 30/331; G06F 119/12

(52) U.S. Cl. CPC G06F 30/331; G06F 2119/12

(57) ABSTRACT

This application discloses a hardware-assisted verification system including a computing system to assign partitions of a circuit design describing an electronic system to transmission circuitry and reception circuitry of the hardware-assisted verification system. The computing system can identify a communication link configured to send one or more data signals from the transmission circuitry to the reception circuitry, select at least one of the data signals capable of being predicted and transmitted during an earlier transmission cycle to the reception circuitry over the communication link, and integrate a prediction system into the transmission circuitry. The prediction system can predict future values for the selected data signal, which the transmission circuitry sends to the reception circuitry over the communication link during the earlier transmission cycle. The hardware-assisted verification system can perform functional verification operations on the circuit design with the predicted future values for the selected data signal.

### FIELD

This application is generally related to electronic design automation and, more specifically, to communication link latency tolerance for hardware assisted verification systems.

### BACKGROUND

Designing and fabricating electronic systems typically involves many steps, known as a “design flow.” The particular steps of a design flow often are dependent upon the type of electronic system to be manufactured, its complexity, the design team, and the fabricator or foundry that will manufacture the electronic system from a circuit design. Initially, a specification for a new electronic system can be transformed into a logical design, sometimes referred to as a register transfer level (RTL) description of the electronic system. With this logical design, the electronic system can be described in terms of both the exchange of signals between hardware registers and the logical operations that can be performed on those signals. The logical design typically employs a Hardware Design Language (HDL), such as System Verilog or Very high speed integrated circuit Hardware Design Language (VHDL).

The logic of the electronic system can be analyzed to confirm that it will accurately perform the functions desired for the electronic system, sometimes referred to as “functional verification.” Design verification tools can perform functional verification operations, such as simulating, emulating, and/or formally verifying the logical design. For example, when a design verification tool simulates the logical design, the design verification tool can provide transactions or sets of test vectors generated by a simulated test bench to the simulated logical design. The design verification tools can determine how the simulated logical design responded to the transactions or test vectors, and verify, from that response, that the logical design describes circuitry to accurately perform functions.

For large complex electronic circuit designs, such as SoC (System-on-Chip) designs or the like, software-based simulation may be too slow, as an execution speed of a simulator can drop significantly as a design size increases, for example, due to cache misses and memory swapping. A hardware assisted verification system performing emulation or prototyping can significantly increase verification productivity by employing reconfigurable hardware modeling devices, such as programmable logic devices or Field Programmable Gate Arrays (FPGAs), which can be configured to perform circuit verification generally in parallel as the circuit design will execute in a real device.

In order for a hardware assisted verification system to implement the circuit design for functional verification operations, the logical design of the electronic circuit can be synthesized from the register transfer level representation into a gate-level representation, such as a gate-level netlist. The synthesis operations can include RTL synthesis, which can generate generic gates corresponding to the functionality described in the logical circuit design. The gate-level netlist describing the electronic circuit can be compiled into a functionally-equivalent model of the gate-level netlist that, when downloaded to the programmable logic devices or FPGAs in the emulator, can cause the programmable logic devices or FPGAs in the emulator to implement the electronic circuit design described by the gate-level netlist.

While the reconfigurable hardware modeling devices typically connect with each other through high-speed links, oftentimes not all connections between them in a hardware assisted verification system can be direct connections, for example, because there may not be enough links per reconfigurable hardware modeling device to reach all other reconfigurable hardware modeling devices in the hardware assisted verification system. The hardware assisted verification systems overcome this lack of direct connection by having multiple channel traversals through intermediate circuitry, which can introduce transmission latency. Similarly, the number of logical signals connecting to or from the portion of a design in a specific hardware modeling device to or from design portions in other hardware modeling devices, either with respect to a specific other modeling device or in aggregate, may exceed the number of communication links available. In such cases, it is common to use time-division multiplexing to transmit multiple signals over a single physical communication link. When the hardware assisted verification system includes a communication link with latency, such as a link in a time-division multiplexed communication channel, a bound on a duration of a computation cycle for the reconfigurable hardware modeling devices corresponds to that latency plus a number of bits to transmit across the communication link divided by the bit rate over the communication link. As computational capacity of the reconfigurable hardware modeling devices has increased, this bound on the duration of the computation cycle has become a bottleneck. Attempts to circumvent this bound by selectively altering the length of the computational cycle for bottlenecked sections of the hardware assisted verification system remain difficult to implement.

### SUMMARY

This application discloses a hardware-assisted verification system including a computing system to assign partitions of a circuit design describing an electronic system to modeling devices and specific connections of the partition to transmission circuitry and reception circuitry of the hardware-assisted verification system. The computing system can identify a communication link configured to send one or more data signals from the transmission circuitry to the reception circuitry, select at least one of the data signals capable of being predicted and transmitted during an earlier transmission cycle to the reception circuitry over the communication link, and integrate a prediction system into the transmission circuitry. The prediction system can predict future values for the selected data signal, which the transmission circuitry sends to the reception circuitry over the communication link during the earlier transmission cycle. The hardware-assisted verification system can perform functional verification operations on the circuit design with the predicted future values for the selected data signal. Embodiments will be described below in greater detail.

### DESCRIPTION OF THE DRAWINGS

FIG. 1A shows an illustrative example of an emulation system with an emulator being coupled to targets.

FIG. 1B shows an illustrative example of an emulation circuit board.

FIG. 2 illustrates a programmable computer system which various embodiments of the disclosed technology may employ.

FIG. 3 illustrates an example hardware assisted verification system including a compilation system implementing communication link latency tolerance according to various embodiments.

FIGS. 4A and 4B illustrate examples of latency bounded communication between transmission circuitry and reception circuitry with corresponding timing diagram according to various embodiments.

FIGS. 4C and 4D illustrate examples of a communication system with prediction-enabled transmission circuitry to implement communication link latency tolerance according to various embodiments.

FIG. 4E illustrates an example of a communication system with cycle variant tolerant reception circuitry to implement communication link latency tolerance according to various embodiments.

FIG. 5 illustrates a flowchart showing example communication link latency tolerance for a hardware assisted verification system according to various examples.

### DETAILED DESCRIPTION

### General Considerations

Various aspects of the present disclosed technology relate to techniques for communication link latency tolerance in hardware assisted verification systems. In the following description, numerous details are set forth for the purpose of explanation. However, one of ordinary skill in the art will realize that the disclosed technology may be practiced without the use of these specific details. In other instances, well-known features have not been described in detail to avoid obscuring the present disclosed technology.

Some of the techniques described herein can be implemented in software instructions stored on a computer-readable medium, software instructions executed on a computer, or some combination of both. Some of the disclosed techniques, for example, can be implemented as part of an electronic design automation (EDA) tool. Such methods can be executed on a single computer or on networked computers.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “operate” and “connect” to describe the disclosed methods/systems. Such terms are high-level descriptions of the actual operations that are performed. The actual operations that correspond to these terms will vary depending on the particular implementation and are readily discernible by one of ordinary skill in the art.

Also, as used herein, the term “design” is intended to encompass data describing an entire integrated circuit device. This term also is intended to encompass a smaller group of data describing one or more components of an entire device, however, such as a portion of an integrated circuit device. Still further, the term “design” also is intended to encompass data describing more than one microdevice, such as data to be used to form multiple microdevices on a single wafer.

### Illustrative Hardware Modeling Environment

Reconfigurable hardware modeling devices can be emulators or prototyping devices. Two types of emulators have been developed. The first type is FPGA-based. In an FPGA-based architecture, each FPGA chip (reconfigurable hardware modeling circuit) has a network of prewired blocks of look-up tables and coupled flip-flops. A look-up table can be programmed to be a Boolean function, and each of the look-up tables can be programmed to connect or bypass the associated flip-flop(s). Look-up tables with connected flip-flops act as finite-state machines, while look-up tables with bypassed flip-flops operate as combinational logic. The look-up tables can be programmed to mimic any combinational logic of a predetermined number of inputs and outputs. To emulate a circuit design, the circuit design is first compiled and mapped to an array of interconnected FPGA chips. The compiler usually needs to partition the circuit design into pieces (sub-circuits) such that each fits into an FPGA chip. The sub-circuits are then synthesized into the look-up tables (that is, generating the contents in the look-up tables such that the look-up tables together produce the function of the sub-circuits). Subsequently, place and route are performed on the FPGA chips in a way that preserves the connectivity in the original circuit design.

The programmable logic chips (reconfigurable hardware modeling circuits) employed by an emulator may be commercial FPGA chips or custom-designed emulation chips containing programmable logic blocks. A custom FPGA-based emulator can have a specially designed internal interconnection network of programmable elements within each custom FPGA, an external interconnecting network and I/O structure of custom FPGAs, and a design-under-test debug engine. Such architecture enables, compared to a commercial FPGA-based counterpart, fast and correct-by-construction compilation and high design visibility in the silicon fabric that can assume 100% access without probe compilation and rapid waveform tracing. A commercial FPGA chip may have somewhat larger capacity density than a custom FPGA chip. For a given design, a custom FPGA-based emulator may need more FPGAs than a commercial FPGA-based emulator, leading to larger physical dimensions and higher power consumption.

The second type of emulators is processor-based: an array of Boolean processors (reconfigurable hardware modeling circuits) able to share data with one another is employed to map a circuit design, and Boolean operations are scheduled and performed accordingly. Similar to the FPGA-based, the circuit design needs to be partitioned into sub-circuits first so that the code for each sub-circuit fits the instruction memory of a processor. The compilation speed of a processor-based emulator, however, is much faster than those of a FPGA-based emulator. Drawbacks are limited speed of execution in a transaction-based mode, large power consumption, and large physical dimensions compared to a FPGA-based emulator.

In addition to emulators, reconfigurable hardware modeling devices also include FPGA prototyping devices. FPGA prototyping is typically deployed near the end of the verification process to catch system-level issues. For designs that rely heavily on commercial intellectual property (IP), an FPGA-based prototype is an ideal test platform for ensuring all IP components perform together. An FPGA-based prototype can also serve as a vehicle for software development and validation. Embedded software has become the dominant part of the effort in modern System-on-Chip (SoC) design. FPGA prototyping provides software developers early access to a fully functioning hardware platform well before real silicon. This enables early software development tasks such as operating system (OS) integration and application testing. The increased productivity of software development and validation greatly accelerates a product's time-to-market.

Compared to FPGA-based emulators which typically operate at two to five million cycles per second, FPGA prototypes are designed and built to achieve the highest speed of execution possible, allowing the extension of the speed range into tens of megahertz. The downside to FPGA prototyping is capacity limitations, limited debugging capabilities and long bring-up time. With growing complexity of FPGAs and advancement in both emulation and prototyping technologies, the lines between FPGA-based prototyping and emulation are increasingly blurring.

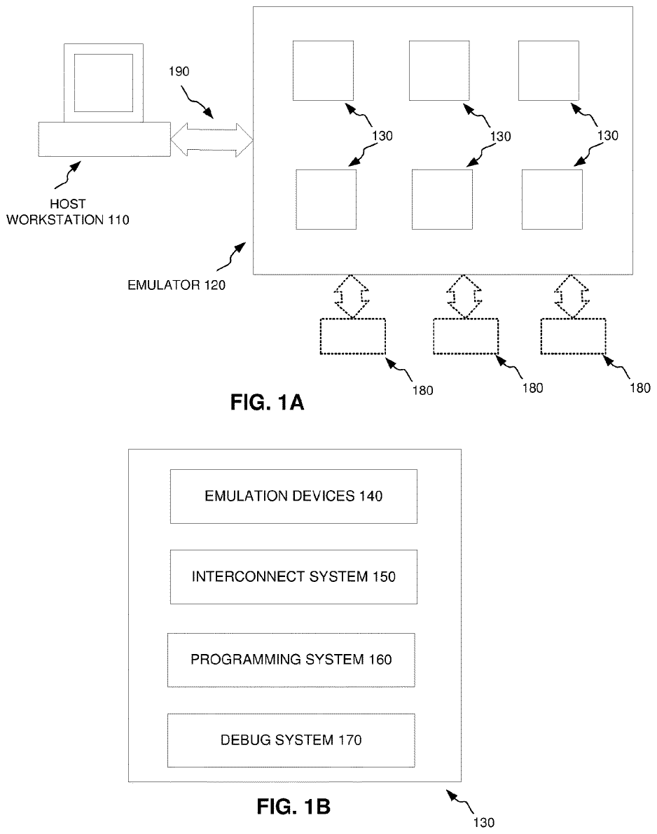

In some embodiments, the disclosed technology may be implemented as part of a hardware emulation environment, such as the one illustrated in FIG. 1A. As seen in this figure, the hardware emulation environment includes an emulator 120 coupled to a host computer or workstation 110. The workstation 110 may be implemented by one or more computing systems. One computing system may include a single computer or multiple computers (e.g., a master computer and a plurality of slave computers). The workstation provides the capability to load the DUV (design-under-verification, also referred to as DUT—design under test) model into the emulator, controls the execution of the DUV model on the emulator over time, and serves as a debugging interface into the DUV model on the emulator. As discussed previously, the workstation may include the testbench and perhaps other software models in some of the operational modes.

The emulator 120 includes multiple printed circuit boards (emulation circuit boards) 130. These emulation circuit boards 130 are networked (not shown). A circuit design may be partitioned by the workstation 110 and loaded to the emulation circuit boards 130 for emulation often along with testbench elements.

In an in-circuit emulation mode, one or more targets 180 may be coupled to the emulator 120 as shown in FIG. 1A. In some simple environments, a target may be a piece of test equipment that generates and verifies test data such as a network tester. In other environments, the target can be the actual circuitry with which the DUT model will interact in its final application (e.g., other hardware components of the system for which the DUT model is designed). A target can be either a static target or a dynamic target, depending on whether design clock signals run in the emulator can be suspended or not.

FIG. 1B illustrates an example of an emulation circuit board 130. The emulation circuit board 130 includes an array of emulation devices 140 (reconfigurable hardware modeling circuits). The emulation devices 140 can be programmed to model, for example, combinatorial logic elements, sequential circuit elements and memories. The emulation devices 140 may be processor-based or FPGA-based.

Also included in the emulation circuit board 130 are a configurable interconnect system 150, a programming system 160, and a debug system 170. A portion of a circuit design on one emulation device may need data computed by another portion of the design on another emulation device. The configurable interconnect system 150 allows data to be moved between emulation devices 140. In some implementations, the configurable interconnect system 150 may include a cross-bar device, a multiplexer, some other configurable network, or any combination thereof.

The programming system 160 enables a variety of other types of data to be brought in or out from an emulation device 140. Examples include programming data to configure an emulation device to perform a particular function, visibility data collected from the debug system 170 to be brought to the host workstation 110 for display, and content data either read from or written to memory circuitry in an emulation device 140.

The debug system 170 enables the emulation system to monitor the behavior of a modeled circuit design. Needed data for visibility viewing purposes can be stored in the debug system 170. The debug system 170 may also provide resources for detecting specific conditions occurring in the circuit design. Such condition detection is sometimes referred to as triggering.

The emulator 120 is coupled to the host workstation 110 through an interface system 190. The interface system 190 comprises one or more interfaces. A typical interface is optimized to transport large amounts of data such as data containing the emulated circuit design model (e.g., FPGA configuration bitstreams), initial contents of registers and design memories and data for debugging purposes. This interface is independent of design-under-test and may comprise dedicated logic or programmed logic in the emulator.

The interface system may also comprise one or more transaction-level interfaces. These interfaces may be optimized for small packets of data and fast streaming speed. The speed may be, for example, in the order of 2-3 Gigabits per second. The communication is performed through transactors as discussed previously. A transactor includes a back-end bus-functional model-instrumented logic in the emulator model, which may require the emulator infrastructure clock keep running even though the design clocks can be stopped.

It should also be appreciated that the emulation system in FIG. 1A and the emulation circuit board 130 in FIG. 1B are illustrated as examples only, and they are not intended to be limiting. Various embodiments of the disclosed technology may be implemented using only a subset of the components illustrated in the figures, or include an alternate combination of components, including components that are not shown in the figures.

### Illustrative Computer-Based Operating Environment

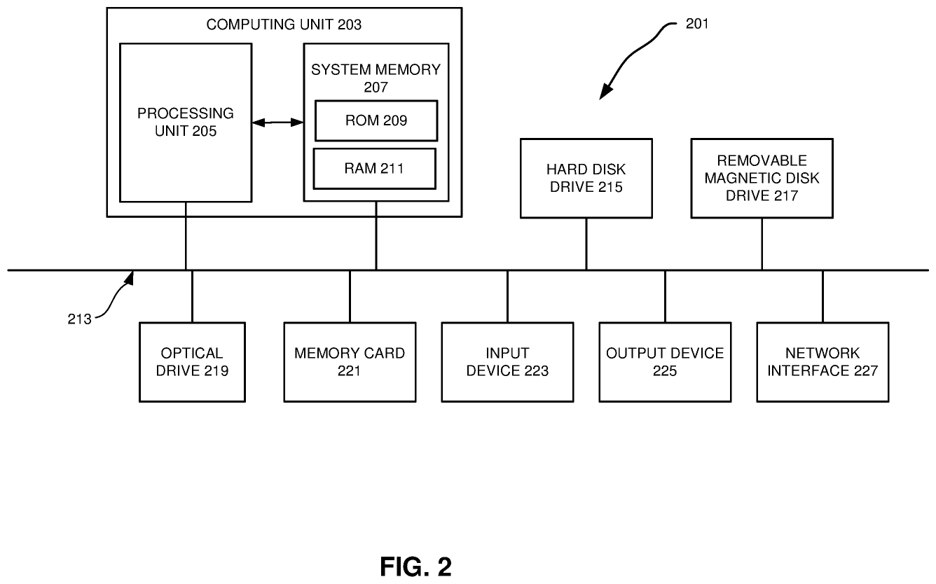

FIG. 2 shows an illustrative example of a computing device 201 which may serve as the workstation 110 and/or implement various embodiments of a part or whole of the disclosed technology. As seen in this figure, the computing device 201 includes a computing unit 203 with a processing unit 205 and a system memory 207. The processing unit 205 may be any type of programmable electronic device for executing software instructions, but will conventionally be a microprocessor. The system memory 207 may include both a read-only memory (ROM) 209 and a random access memory (RAM) 211. As will be appreciated by those of ordinary skill in the art, both the read-only memory (ROM) 209 and the random access memory (RAM) 211 may store software instructions for execution by the processing unit 205.

The processing unit 205 and the system memory 207 are connected, either directly or indirectly, through a bus 213 or alternate communication structure, to one or more peripheral devices. For example, the processing unit 205 or the system memory 207 may be directly or indirectly connected to one or more additional memory storage devices, such as a “hard” magnetic disk drive 215, a removable magnetic disk drive 217, an optical disk drive 219, or a flash memory card 221. The processing unit 205 and the system memory 207 also may be directly or indirectly connected to one or more input devices 223 and one or more output devices 225. The input devices 223 may include, for example, a keyboard, a pointing device (such as a mouse, touchpad, stylus, trackball, or joystick), a scanner, a camera, and a microphone. The output devices 225 may include, for example, a monitor display, a printer and speakers. With various examples of the computer 201, one or more of the peripheral devices 215-225 may be internally housed with the computing unit 203. Alternately, one or more of the peripheral devices 215-225 may be external to the housing for the computing unit 203 and connected to the bus 213 through, for example, a Universal Serial Bus (USB) connection.

With some implementations, the computing unit 203 may be directly or indirectly connected to one or more network interfaces 227 for communicating with other devices making up a network. The network interface 227 translates data and control signals from the computing unit 203 into network messages according to one or more communication protocols, such as the transmission control protocol (TCP) and the Internet protocol (IP). Also, the interface 227 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 201 is illustrated as an example only, and is not intended to be limiting. Various embodiments of the disclosed technology may be implemented using one or more computing devices that include the components of the computer 201 illustrated in FIG. 2, which include only a subset of the components illustrated in FIG. 2, or which include an alternate combination of components, including components that are not shown in FIG. 2. For example, various embodiments of the disclosed technology may be implemented using a multi-processor computer, a plurality of single and/or multiprocessor computers arranged into a network, or some combination of both.

### Communication Link Latency Tolerance for Hardware Assisted Verification Systems

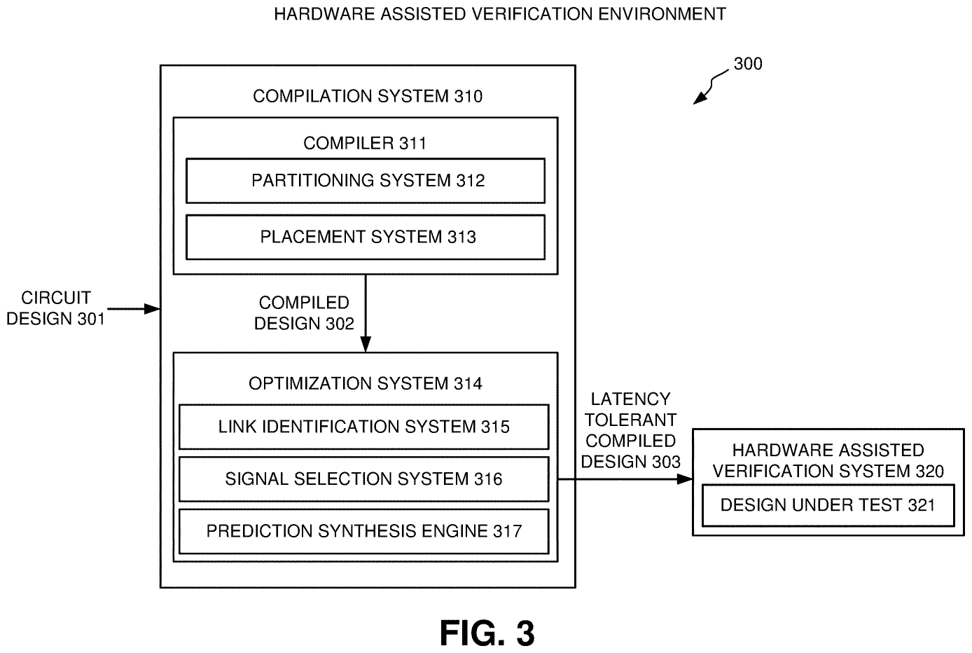

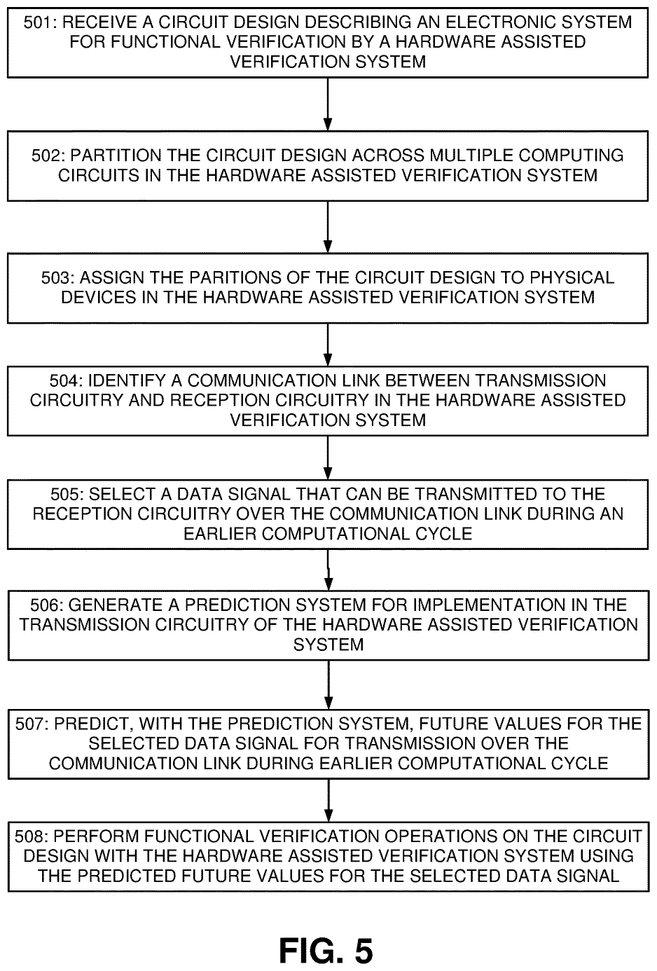

FIG. 3 illustrates an example hardware assisted verification environment 300 including a compilation system 310 implementing communication link latency tolerance according to various embodiments. FIG. 5 illustrates a flowchart showing example communication link latency tolerance for a hardware assisted verification system according to various examples. Referring to FIGS. 3 and 5, the compilation system 310, in a block 501 of FIG. 5, can receive a circuit design 301 describing an electronic system at a register transfer level (RTL), for example, with code in a hardware description language (HDL), such as SystemVerilog, Very high speed integrated circuit Hardware Design Language (VHDL), System C, or the like. In some embodiments, the circuit design 301 describing the electronic system can be a synthesized gate-level representation of the register transfer level representation, such as a gate-level netlist, for example, generated by a synthesis tool. The synthesis operations can include RTL synthesis, which can generate generic gates corresponding to the functionality described in the circuit design 301.

The compilation system 310 can include a compiler 311 to compile the gate-level netlist describing the electronic system into a compiled design 302 corresponding to a functionally-equivalent model of the gate-level netlist. The compilation system 310 can include an optimization system 314 to perform various optimizations on the compiled design 302, such as modifying the compiled design 302 into a latency tolerant compile design 303, which can be a functionally-equivalent model of the gate-level netlist with increased tolerance to communication link latency in the hardware assisted verification system 320. The latency tolerant compiled design 303, when downloaded to reconfigurable hardware modeling circuits in a hardware assisted verification system 320, such as programmable logic devices or Field Programmable Gate Arrays (FPGAs), Boolean processors, or the like, can cause the reconfigurable hardware modeling circuits in the hardware assisted verification system 320 to implement the electronic system described by the gate-level netlist as a design under test 321.

The hardware assisted verification system 320, in some embodiments, also can implement a test bench, which can provide transactions or sets of test vectors to the design under test 321 in the hardware assisted verification system 320. For example, when the hardware assisted verification system 320 emulates the circuit design 301, the hardware assisted verification system 320 can provide transactions or sets of test vectors generated by the test bench to the design under test 321. The hardware assisted verification system 320 can determine how the design under test 321 responded to the transactions or test vectors, and verify, from those responses, that the circuit design 301 describes the electronic system capable of accurately performing desired functions.

The compiler 311 can include a partition system 312 that, in a block 502 of FIG. 5, can partition the circuit design 301 across multiple computing circuits in the hardware assisted verification system, for example, by dividing the circuit design 301 into multiple sub-circuit designs. The partition system 312 can determine where to partition the circuit design 301 based, at least in part, on a size or modeling capacity of the reconfigurable hardware modeling circuits in the hardware assisted verification system 320 and/or a number communication signals or links between different portions of the circuit design 301. The partition system 312, in some embodiments, can utilize physical specifications of the hardware assisted verification system 320, such as a number of the reconfigurable hardware modeling circuits in the hardware assisted verification system 320, capacities of the reconfigurable hardware modeling circuits, hardware partitions in the hardware assisted verification system 320, e.g., between different reconfigurable hardware modeling circuits, printed circuit boards, chassis, sub-systems in the reconfigurable hardware modeling circuits, or the like, physical distances between partitions, data translation between the partitions, power domain crossings across partitions, a serializer/deserializer (SERDES) interface between partitions, or the like. In some embodiments, the partition system 312 can determine where to partition the circuit design 301 based, at least in part, on the physical specifications of the hardware assisted verification system 320.

The compiler 311 can include a placement system 313 that, in a block 503 of FIG. 5, can assign the partitions of the circuit design 301 to the physical resources in the hardware assisted verification system 320, such as the reconfigurable hardware modeling circuits. The placement system 313 can identify communication channels and communication links available between reconfigurable hardware modeling circuits in the hardware assisted verification system 320 and assign the partitions of the circuit design 301 to the reconfigurable hardware modeling circuits based, at least in part, on the available communication channels and communication links between reconfigurable hardware modeling circuits and the identified number communication signals or links between the partitions of the circuit design 301. In some embodiments, the hardware assisted verification system 320 can include several different types of interconnects between the reconfigurable hardware modeling circuits, for example, communication links having high bit rates with high-latency and having low bit rates with low latency. The placement system 313 can assign the partitions of the circuit design 301 to the reconfigurable hardware modeling circuits based, at least in part, on the type of communication links available between the reconfigurable hardware modeling circuits. The compiler 311 can compile the circuit design 301 into a compiled design 302 corresponding to a functionally-equivalent model of the gate-level netlist.

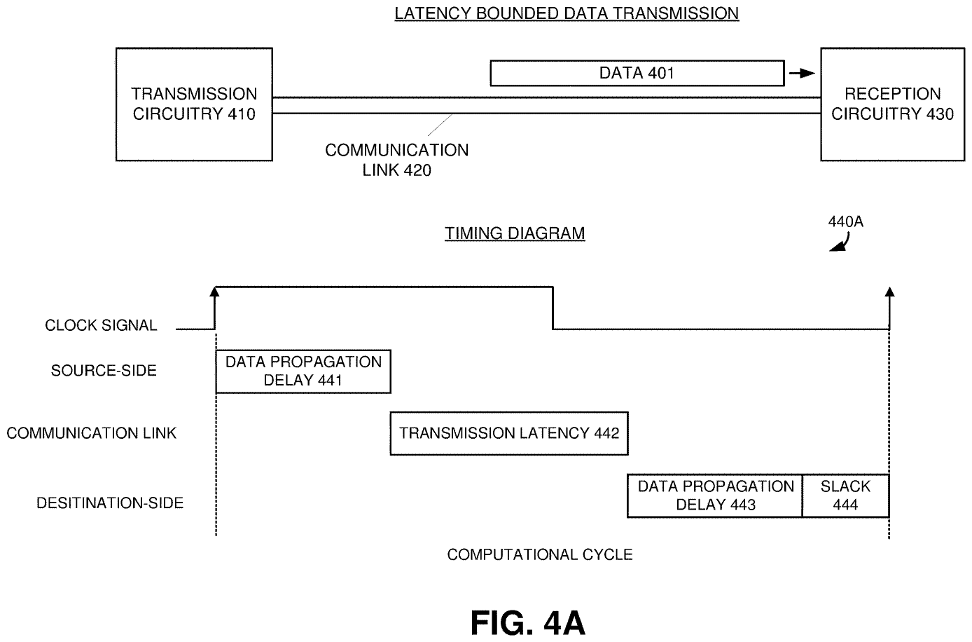

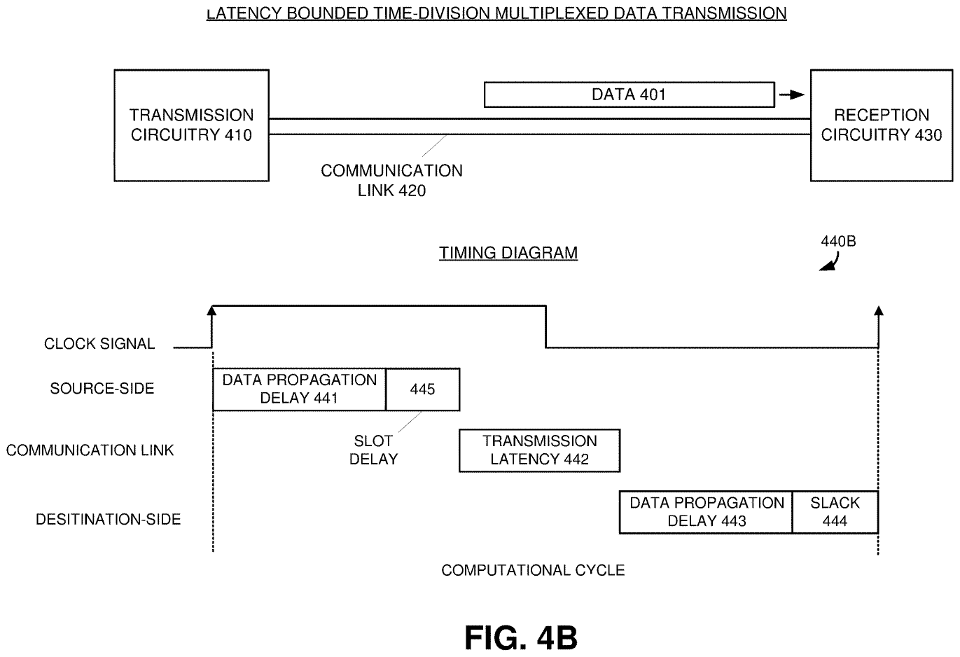

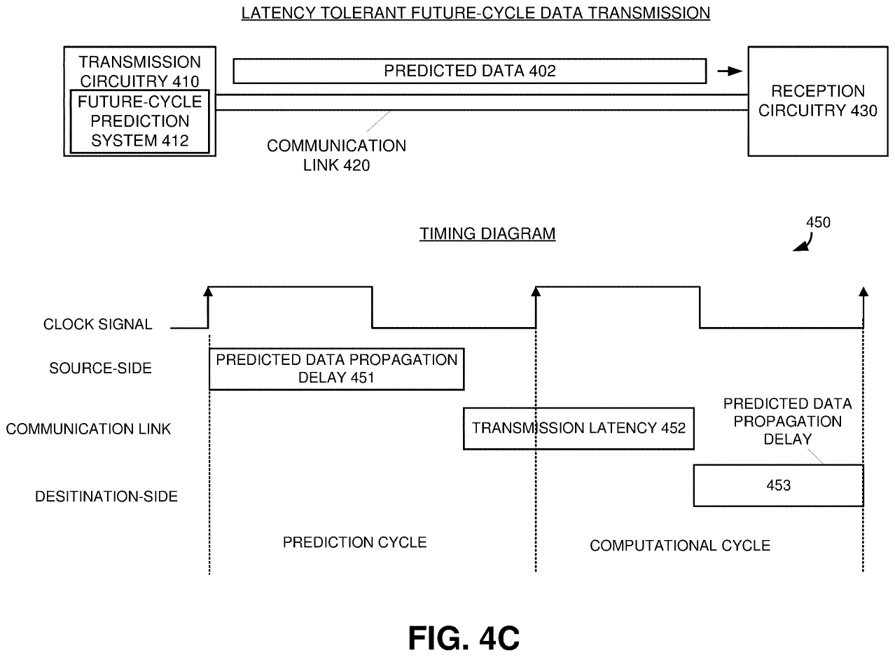

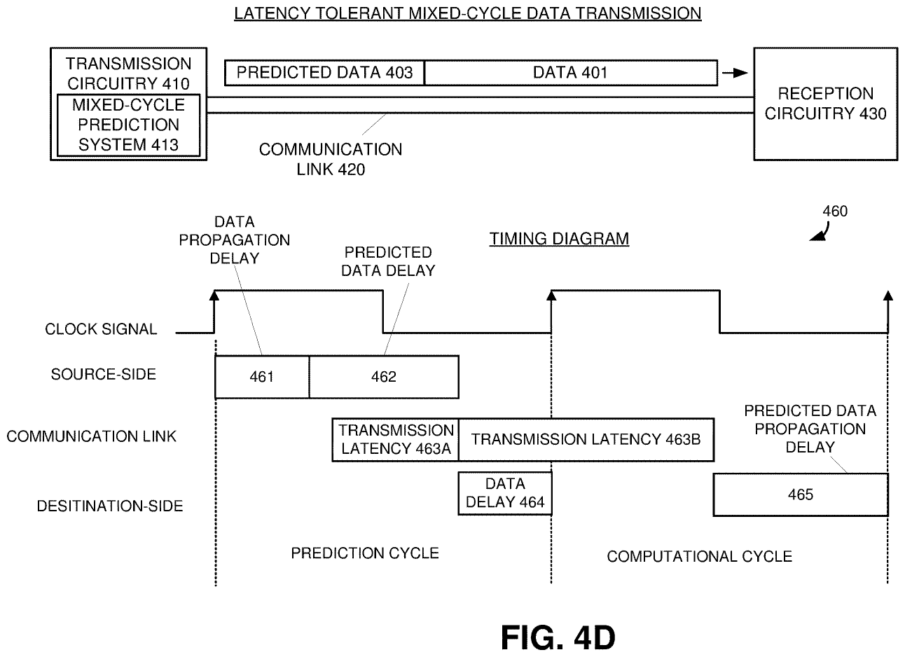

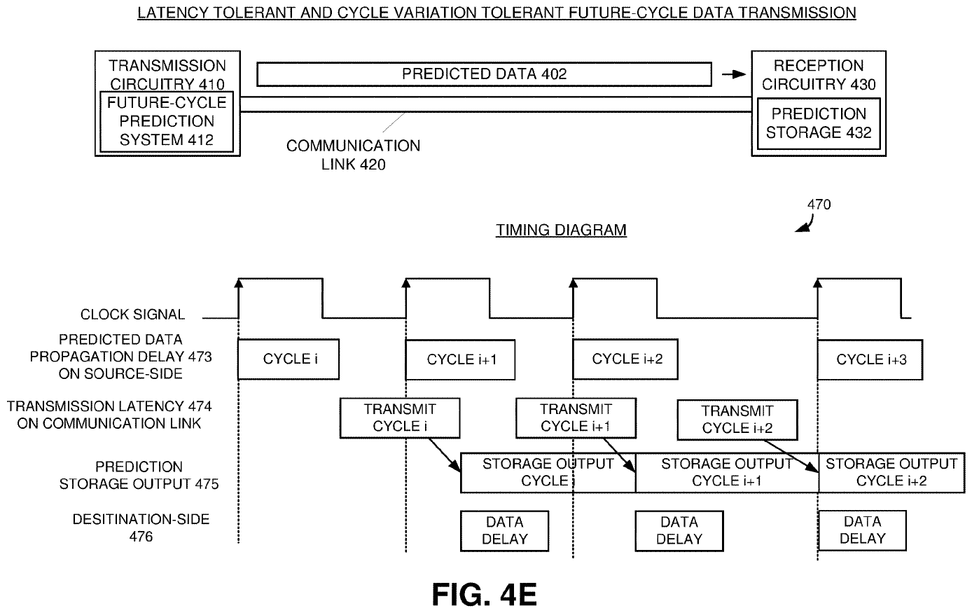

The optimization system 314 can receive the compiled design 302 from the compiler 311 and modify a compiled design 302 into the latency tolerant compiled design 303, which can at least partially relieve communication links between reconfigurable hardware modeling circuits from a performance bound based, at least in part, on a transmission latency relative to a computation cycle of the reconfigurable hardware modeling circuits. An example of a latency bounded communication link will be described below with reference to FIGS. 4A and 4B in greater detail.

FIG. 4A illustrates an example of latency bounded communication between transmission circuitry 410 and reception circuitry 430 with corresponding timing diagram 440A according to various embodiments. Referring to FIG. 4A, the transmission circuitry 410 can include combinational logic that, in response to a clock signal, can generate data 401 and transmit the data 401 over a communication link 420. In some embodiments, the communication link 420 can be a time slot in a time-division multiplexed interconnect between the transmission circuitry 410 and the reception circuitry 430. The timing diagram 440A shows a time interval corresponding to a data propagation delay 441 during which the computation of a signal value or data 401 occurs via combinatorial logic on the source side based on new data available at a clock edge. The time interval corresponding to the data propagation delay 441 can be followed by a time interval corresponding to a transmission latency 442 during which the signal value or data 401 traverses the communication link 420. The timing diagram 440A also shows a time interval corresponding to data propagation delay 443 during which a destination-side receives the signal value or data 401, potentially utilized in a further computation via more combinatorial values available prior to a next edge of the clock signal. The time interval corresponds to slack 444 or potential extra time available if the further computation completes before the next edge of the clock signal. In some examples, the shortest valid time for the time interval between edges of the signal corresponds to the clock period at which the path with longest total values of the data propagation delay 441, the transmission latency 442, and the data propagation delay 443 has no extra time, so the time interval corresponding to the slack 444 can have zero duration.

FIG. 4B illustrates an example of latency bounded communication across a time-division multiplexed interconnect link between transmission circuitry 410 and reception circuitry 430 with corresponding timing diagram 440B according to various embodiments. For latency bounded communication across a time-division multiplexed interconnect link, multiple signals can be sent across the communication link 420 in a series of successive timeslots may incur an extra time interval or a slot delay 445 between the completion of the data propagation delay 441 and start of transmission latency 442 during which other signals can be transmitted on the communication link 420 ahead of the data 401. If there is a slot delay 445 or time spent waiting for an assigned communication slot on the communication link 420, then the minimum clock period includes the slot delay, limiting the clock period by the path with combined values of the data propagation delay 441, the transmission latency 442, the data propagation delay 443, and the slot delay 445.

Referring to both FIGS. 4A and 4B, as shown in the timing diagrams 440A and 440B, the amount of the data 401 that the transmission circuitry 410 can generate and transmit to the reception circuitry 430 can be bounded at least partially by a transmission latency 442 and data propagation delays 441 and 443 over the communication link 420 relative to the duration of the computation cycle. The bounding of performance due to the link latency can limit an amount of the data 401 that can be generated and transmitted during the computational cycle and also leave the communication link 420 unused for a period of time, e.g., when the transmission latency 442 over the communication link 420 exceeds the time remaining to transmit data to the reception circuitry 430 before the next clock edge.

Referring back to FIGS. 3 and 5, the optimization system 314 can include a link identification system 315 to locate communication links coupled between reconfigurable hardware modeling circuits in the compiled design 302. The link identification system 315, in a block 504 of FIG. 5, can identify the communication link between transmission circuitry and reception circuitry in the hardware assisted verification system 302. The transmission circuitry and the reception circuitry can correspond to generic reconfigurable hardware modeling circuits in the hardware assisted verification system 302 that can transmit and receive one or more data signals over the communication link, respectively. In some embodiments, the transmission circuitry can be considered reception circuitry for a different data signal or different communication link, while the reception circuitry can be considered transmission circuitry for a different data signal or different communication link. The link identification system 315 can determine the characteristics of those identified communication links, such as their bit rate and transmission latency. The link identification system 315 can identify at least one of the located communication links as potentially being latency bounded, for example, having capped data throughput due to the transmission latency on the identified communication link.

The optimization system 314 can include a signal selection system 316 to determine which data signals communicated between the reconfigurable hardware modeling circuits over the identified communication links can be predicted at least one computational cycle earlier, and communicated over the links in a latency tolerant manner. The signal selection system 316, in a block 505 of FIG. 5, can select at least one of the data signals capable of being predicted at least one computational cycle early for use in modifying the compiled design 302 into the latency tolerant compiled design 303. The signal selection system 316 can determine which of the data signals can be predicted at least one computational cycle earlier by ascertaining whether the reconfigurable hardware modeling circuit configured as transmission circuitry has received data values from other circuitry in the hardware assisted verification system 320 to be able to compute predicted future values of the data signals. The signal selection system 316, in some embodiments, can determine whether the prediction computation can wholly be performed in the transmission circuitry. The signal selection system 316 also can select the data signals capable of being predicted at least one computational cycle early based, at least in part, on when the predicted data signals would be received by the reconfigurable hardware modeling circuit configured as reception circuitry over the communication link.

The optimization system 314 can include a prediction system synthesis engine 317 that, in a block 506 of FIG. 5, can generate a prediction system describing circuitry to predict future values at least one cycle early for each of the selected data signals. When all of the data signals on communication link were selected by the signal selection system 316, the prediction system synthesis engine 317 generate a future-value prediction system, which can predict future values for the selected data signals. When less than all of the data signals on communication link were selected by the signal selection system 316, the prediction system synthesis engine 317 generate a mixed-cycle prediction system, which can predict future values for the selected data signals, while generating current values for the non-selected data signals.

The prediction system synthesis engine 317 can modify the compiled design 302 to generate the latency tolerant compiled design 303 by incorporating the generated prediction system into the compiled design 302. In some embodiments, the prediction system synthesis engine 317 can replace the transmission circuitry with the prediction system, while in other embodiments, the prediction system can be integrated within the transmission circuitry. Example of latency tolerant data transmission with transmission-side integration of a prediction system will be described below with reference to FIGS. 4C and 4D in greater detail.

FIGS. 4C and 4D illustrate examples of a communication system with prediction-enabled transmission circuitry to implement communication link latency tolerance according to various embodiments. Referring to FIG. 4C, the transmission circuitry 410 can include a future-cycle prediction system 412 to generate future values for a data signal and transmit the future values as predicted data 402 to reception circuitry 430 over a communication link 420. The future-cycle prediction system 412 can generate the predicted data 402 at least one computational cycle earlier, for example, than the generation of data 401 in FIG. 4A. For example, in the timing diagram 450, the future-cycle prediction system 412 can generate the predicted data 402 and transmit the predicted data 402 to the reception circuitry 430 in response to a clock signal initiating a prediction cycle. The timing diagram 450 shows a time interval corresponding to a predicted data propagation delay 451 during which the computation of the predicted data 402 occurs via combinatorial logic on the source side based on new data available at a clock edge. The time interval corresponding to the predicted data propagation delay 451 can be followed by a time interval corresponding to a transmission latency 452 during which the predicted data 402 traverses the communication link 420. The timing diagram 450 also shows a time interval corresponding to predicted data propagation delay 453 during which a destination-side receives the predicted data 402. The predicted data 402 can arrive at the destination-side during the computational cycle in advance of a subsequent edge of the clock signal. The latency tolerant communication based on sending predicted data from a prediction system has two features observed in timing diagram 450. The source propagation delay, transmission latency and destination propagation delay have two clock cycles of time to occur rather than one clock cycle as shown in timing diagrams 440A or 440B. The latency tolerant communication based on sending predicted data from a prediction system can utilize the communication link 420 during times that were previously unavailable because the data would arrive to the reception circuitry 430 after the transition to the next computational cycle. The predicted data intentionally arrives in the cycle after the prediction cycle as that corresponds to the cycle in which the data can be used by the design.

Referring to FIG. 4D, the transmission circuitry 410 can include combinational logic that, in response to a clock signal, can generate the data 401 and transmit the data 401 over a communication link 420 similar to as described above with reference to Figure 4A. The data 401 can arrive at the reception circuitry 430 for processing within the same cycle of the hardware assisted verification system.

The transmission circuitry 410 can include a mixed-cycle prediction system 413 to generate future values for selected data signals and transmit the future values as predicted data 403 to the reception circuitry 430 over the communication link 420 after the transmission of the data 401 in the first computational cycle. The timing diagram 460 shows a time interval corresponding to a data propagation delay 461 during which the computation of the data 401 occurs via combinatorial logic on the source side based on new data available at a clock edge, and a time interval corresponding to a predicted data propagation delay 462 during which the computation of the predicted data 403 also occurs via combinatorial logic on the source side based on new data available at a clock edge. The time interval corresponding to the data propagation delay 461 can be followed by a time interval corresponding to a transmission latency 463A during which the data 401 traverses the communication link 420. The time interval corresponding to the predicted data propagation delay 462 can be followed by a time interval corresponding to a transmission latency 463B during which the predicted data 403 traverses the communication link 420. The timing diagram 460 shows a time interval corresponding to data propagation delay 464 during which a destination-side receives the data 401. The data 401 can arrive at the destination-side during the same clock cycle in advance of a subsequent edge of the clock signal. The timing diagram 460 also shows a time interval corresponding to predicted data propagation delay 465 during which a destination-side receives the predicted data 403. The predicted data 403 can arrive at the destination-side during the computational cycle in advance of a subsequent edge of the clock signal in the cycle following the prediction cycle. For example, in the timing diagram 460, the mixed-cycle prediction system 413 can generate the data 401 and the predicted data 403 and transmit the predicted data 403 to the reception circuitry 430.

Referring back to FIGS. 3 and 5, the prediction system synthesis engine 317 also can generate prediction storage describing circuitry to store received predicted data signals from transmission circuitry. The prediction storage, when implemented in the hardware assisted verification system 320, can correspond to a storage device for the received predicted future values of the selected data signals received over the communication link. The storage of the predicted future values of the selected data signals can be utilized by the reception circuitry when dealing with cycle variation, such as when the hardware assisted verification system 320 has a clock stopping event or have the frequency of the clock signal altered. In some embodiments, the identified communication link can be a part of a multi-link path in the hardware assisted verification system 320, which allows the reception circuitry to utilize the prediction storage to delay retransmission of the predicted future values over the second link in the multi-link path until a start of a subsequent computation cycle, which aligns the predicted future values from an earlier computational cycle to an on-time computational cycle.

The prediction system synthesis engine 317 can modify the compiled design 302 to generate the latency tolerant compiled design 303 by incorporating the generated prediction storage into the reception circuitry associated with the selected data signals in the compiled design 302. Example of cycle variation tolerant data transmission with latency variation tolerant data transmission will be described below with reference to FIG. 4E in greater detail.

FIG. 4E illustrates an example of a communication system with cycle variant tolerant reception circuitry to implement communication link latency tolerance according to various embodiments. Referring to FIG. 4E, the transmission circuitry 410 can transmit predicted data 402 similarly to as described above with reference to FIG. 4C. The reception circuitry 430 can include prediction storage 432, which can retain the predicted data 402 transmitted over the communication link 420. The retention of the predicted data 402 can allow the reception circuitry 430 to handle cycle variation, such as when the hardware assisted verification system has a clock stopping event or when the frequency of the clock signal has been altered.

The future-cycle prediction system 412 can generate the predicted data 402 at least one computational cycle earlier, for example, than the generation of data 401 in FIG. 4A. For example, in the timing diagram 470, the future-cycle prediction system 412 can generate the predicted data 402 and transmit the predicted data 402 to the prediction storage 432 in the reception circuitry 430 in response to a clock signal initiating a prediction cycle. The timing diagram 470 shows time intervals—cycle i, cycle i+1, cycle i+2, and cycle i+3—corresponding to a predicted data propagation delay 473 during which the computation of the predicted data 402 occurs via combinatorial logic on the source side based on new data available at clock edges. The time intervals corresponding to the predicted data propagation delay 473 can be followed by a time interval corresponding to a transmission latency 474—transmit cycle i, transmit cycle i+1, and transmit cycle i+2—during which the predicted data 402 traverses the communication link 420. The timing diagram 470 shows time intervals corresponding to prediction storage output 475—storage output cycle i, storage output cycle i+1, and storage output cycle i+2—during which the prediction storage 432 outputs the predicted data 402. The prediction storage output 475 for storage output cycle i+1 and storage output cycle i+2 shows that if reception of predicted data 402 occurs within the same clock cycle as transmission, the prediction storage 432 continues to output the prior cycle value until the next clock edge. In some embodiments, the communication link 420 can be a first stage in a multi-link path, which allows the reception circuitry 430 to utilize the prediction storage 432 to delay retransmission of the predicted data 402 and 403 over the second stage in the multi-link path until a start of a subsequent computational cycle. The timing diagram 470 also shows time intervals corresponding to predicted data propagation delay 453 during which a destination-side receives the predicted data 402. The predicted data 402 can arrive at the destination-side during the computational cycle in advance of a subsequent edge of the clock signal.

Referring back to FIGS. 3 and 5, the hardware assisted verification system 320 can download the latency tolerant compiled design 303 to the reconfigurable hardware modeling circuits, which can cause the reconfigurable hardware modeling circuits in the hardware assisted verification system 320 to implement the electronic system described by the gate-level netlist along with the added prediction system(s) and prediction storage(s) as a design under test 321. The prediction system(s) in the hardware assisted verification system 320, in a block 507 of FIG. 5, can predict future values for selected data signal(s) for transmission over the communication link during the earlier transmission cycle. The hardware assisted verification system 320, in a block 508 of FIG. 5, can perform functional verification operations on the circuit design 302 using the predicted future values for the selected data signal.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long as the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### Conclusion

While the application describes specific examples of carrying out embodiments of the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
identifying, by a computing system, a communication link between transmission circuitry and reception circuitry, wherein the transmission circuitry is configured to transmit one or more data signals to the reception circuitry over the communication link;
selecting, by the computing system, at least one of the data signals to transmit to the reception circuitry over the communication link during an earlier computational cycle; and
integrating, by the computing system, a prediction system into the transmission circuitry, wherein the prediction system is configured to predict future values for the selected data signal, and the transmission circuitry is configured to transmit the predicted future values to the reception circuitry over the communication link during the earlier computational cycle.

2. The method of claim 1, wherein selecting at least one of the data signals further comprises identifying which of the data signals are capable of being predicted by the transmission circuitry, wherein selecting at least one of the data signals transmitted over the communication link is based on the identification.

3. The method of claim 2, wherein selecting at least one of the data signals further comprises determining when the reception circuitry utilizes the data signals capable of being predicted, wherein selecting at least one of the data signals transmitted over the communication link is based on the determination.

4. The method of claim 1, further comprising assigning, by the computing system, partitions of a circuit design describing an electronic system to the transmission circuitry and the reception circuitry associated with computing circuits in a hardware-assisted verification system.

5. The method of claim 4, further comprising performing functional verification operations on the circuit design in the hardware-assisted verification system with the predicted future values for the selected data signal.

6. The method of claim 4, wherein integrating the prediction system into the transmission circuitry further comprises configuring the physical devices corresponding to the transmission circuitry in the hardware-assisted verification system to include the circuitry configured to generate the future values of the selected data signal.

7. The method of claim 1, further comprising integrating a prediction storage system into the reception circuitry to store the future values of the selected data signal received over the communication link from the transmission circuitry.

8. A system comprising:
a memory system configured to store computer-executable instructions; and
a computing system, in response to execution of the computer-executable instructions, is configured to:
identify a communication link between transmission circuitry and reception circuitry, wherein the transmission circuitry is configured to transmit one or more data signals to the reception circuitry over the communication link;
select at least one of the data signals to transmit to the reception circuitry over the communication link during an earlier computational cycle; and
integrate a prediction system into the transmission circuitry, wherein the prediction system is configured to predict future values for the selected data signal, and the transmission circuitry is configured to transmit the predicted future values to the reception circuitry over the communication link during the earlier computational cycle.

9. The system of claim 8, wherein the computing system, in response to execution of the computer-executable instructions, is further configured to select at least one of the data signals by identifying which of the data signals are capable of being predicted by the transmission circuitry, wherein selecting at least one of the data signals transmitted over the communication link is based on the identification.

10. The system of claim 9, wherein the computing system, in response to execution of the computer-executable instructions, is further configured to select at least one of the data signals by determining when the reception circuitry utilizes the data signals capable of being predicted, wherein selecting at least one of the data signals transmitted over the communication link is based on the determination.

11. The system of claim 8, further comprising a hardware-assisted verification system having computing circuits, wherein the computing system, in response to execution of the computer-executable instructions, is further configured to assign partitions of a circuit design describing an electronic system to the transmission circuitry and the reception circuitry associated with computing circuits in the hardware-assisted verification system.

12. The system of claim 11, wherein the hardware-assisted verification system is configured to perform functional verification operations on the circuit design with the predicted future values for the selected data signal.

13. The system of claim 11, wherein the computing system, in response to execution of the computer-executable instructions, is further configured to integrate the prediction system into the transmission circuitry by configuring the physical devices corresponding to the transmission circuitry in the hardware-assisted verification system to include the circuitry configured to generate the future values of the selected data signal.

14. An apparatus comprising at least one computer-readable memory device storing instructions configured to cause one or more processing devices to perform operations comprising:
identifying a communication link between transmission circuitry and reception circuitry, wherein the transmission circuitry is configured to transmit one or more data signals to the reception circuitry over the communication link; selecting at least one of the data signals to transmit to the reception circuitry over the communication link during an earlier computational cycle; and
integrating a prediction system into the transmission circuitry, wherein the prediction system is configured to predict future values for the selected data signal, and the transmission circuitry is configured to transmit the predicted future values to the reception circuitry over the communication link during the earlier computational cycle.

15. The apparatus of claim 14, wherein selecting at least one of the data signals further comprises identifying which of the data signals are capable of being predicted by the transmission circuitry, wherein selecting at least one of the data signals transmitted over the communication link is based on the identification.

16. The apparatus of claim 15, wherein selecting at least one of the data signals further comprises determining when the reception circuitry utilizes the data signals capable of being predicted, wherein selecting at least one of the data signals transmitted over the communication link is based on the determination.

17. The apparatus of claim 14, wherein the instructions are configured to cause one or more processing devices to perform operations further comprising assigning partitions of a circuit design describing an electronic system to the transmission circuitry and the reception circuitry associated with computing circuits in a hardware-assisted verification system.

18. The apparatus of claim 17, wherein the instructions are configured to cause one or more processing devices to perform operations further comprising performing functional verification operations on the circuit design in the hardware-assisted verification system with the predicted future values for the selected data signal.

19. The apparatus of claim 17, wherein integrating the prediction system into the transmission circuitry further comprises configuring the physical devices corresponding to the transmission circuitry in the hardware-assisted verification system to include the circuitry configured to generate the future values of the selected data signal.

20. The apparatus of claim 14, further comprising integrating a prediction storage system into the reception circuitry to store the future values of the selected data signal received over the communication link from the transmission circuitry.
